(19) United States
(12) Patent Application Publication
(10) Pub. No.: US 2006/0271798 A1
(43) Pub. Date: Nov. 30, 2006

(54) Configurable interrupt scheme for waking up a system from sleep mode

(75) Inventor: Vinod Vijay Tandon, San Diego, CA (US)

Correspondence Address: FITCH EVEN TABIN AND FLANNERY, 120 SOUTH LA SALLE STREET, SUITE 1600, CHICAGO, IL, 60603-3406, US

(73) Assignee: Sony Computer Entertainment America Inc., Foster City, CA (US)

(21) Appl. No.: 11/141,296

(22) Filed: May 31, 2005

(51) Int. Cl. G06F 1/26

(52) U.S. Cl. 713/300

(57) ABSTRACT

A configurable interrupt scheme provides a way to automatically wake up a system from sleep mode at software configurable times. The scheme helps to save battery life in portable devices because sleep mode can be entered while applications and/or games are running due to the ability to automatically wake up from sleep mode at configurable times. The scheme operates by receiving a specified wake up time in the system during a standard mode of operation, comparing the specified wake up time to a current time during the sleep mode of operation, and waking up the system from the sleep mode of operation in response to the current time being equal to or greater than the specified wake up time. The system can then automatically run or continue running an application or game.

### BACKGROUND OF THE INVENTION

1. Field of the Invention

The present invention relates generally to the conservation of power in processing systems and devices, and more specifically to the sleep mode of operation used in systems such as are embodied in portable devices.

2. Discussion of the Related Art

A so-called “sleep mode” or “suspend mode” is a power management mode in a processing system that shuts down all unnecessary computer operations and/or components, such as the display screen, to save energy. The sleep mode is often used in battery-powered devices, such as for example portable computers, notebook computers, personal digital assistants (PDAs), portable game devices, etc., to conserve battery power. Such devices typically enter the sleep mode when no input has been detected for a certain amount of time.

A device “wakes up” from sleep mode when the user physically operates the device's input mechanisms, such as a keyboard, mouse or other input mechanism. Once awakened from sleep mode, the device returns to its former operating status, or standard, full-on mode of operation, and components such as the display screen are turned back on.

It is with respect to these and other background information factors that the present invention has evolved.

### SUMMARY OF THE INVENTION

The present invention advantageously addresses the needs above as well as other needs by providing a method for use in a system having a sleep mode of operation. The method comprises the steps of: receiving a specified wake up time in the system during a standard mode of operation of the system; comparing the specified wake up time to a current time during the sleep mode of operation of the system; and waking up the system from the sleep mode of operation in response to the current time being equal to or greater than the specified wake up time.

Another embodiment of the present invention provides a system having a sleep mode of operation. The system comprises means for receiving a specified wake up time in the system during a standard mode of operation of the system, means for comparing the specified wake up time to a current time during the sleep mode of operation of the system, and means for waking up the system from the sleep mode of operation in response to the current time being equal to or greater than the specified wake up time.

And another embodiment of the present invention provides a system having a sleep mode of operation. The system comprises a memory that is persistent when the system is in the sleep mode of operation and in which a specified wake up time may be stored, and a counter that continues to operate during the sleep mode of operation of the system. One or more components are configured to compare the specified wake up time to a current time at an end of a tick of the counter during the sleep mode of operation of the system, and one or more components are configured to wake up the system from the sleep mode of operation in response to the current time being equal to or greater than the specified wake up time.

A better understanding of the features and advantages of the present invention will be obtained by reference to the following detailed description of the invention and accompanying drawings which set forth an illustrative embodiment in which the principles of the invention are utilized.

### BRIEF DESCRIPTION OF THE DRAWINGS

The above and other aspects, features and advantages of the present invention will be more apparent from the following more particular description thereof, presented in conjunction with the following drawings wherein:

FIG. 1 is a flow diagram illustrating a method for use in a system having a sleep mode of operation in accordance with an embodiment of the present invention;

FIG. 2 is a flow diagram illustrating a method that may be used for implementing a portion of the method shown in FIG. 1 in accordance with an embodiment of the present invention;

FIG. 3 is a flow diagram illustrating a method that may be used for implementing another portion of the method shown in FIG. 1 in accordance with an embodiment of the present invention; and

FIG. 4 is a block diagram illustrating a device having a system that may use the method shown in FIG. 1 in accordance with an embodiment of the present invention.

Corresponding reference characters indicate corresponding components throughout the several views of the drawings.

### DETAILED DESCRIPTION

Currently, battery life is one of the biggest limiting factors for all types of portable devices. As discussed above, the so-called sleep mode of operation allows a system to sleep in order to save power, such as to save battery power in portable devices like notebook and laptop computers, portable game devices, personal digital assistants (PDAs), etc. In order to wake up a conventional device from sleep mode the user must manually wake it up by physically operating one of the device's input mechanisms, such as a keyboard, mouse or other input mechanism. The device then returns to its standard, full-on mode of operation.

It has been recognized by the inventor hereof that conventional devices do not provide a way to wake up the device from sleep through software running on the device. For example, there is currently no way to wake up a notebook computer from sleep mode from within software.

Embodiments of the present invention provide a way to wake up a system from sleep mode at software configurable times. This means that systems made in accordance with embodiments of the present invention can be programmed to automatically wake up from sleep mode at certain times without the user having to manually wake up the device. This is useful for games and/or applications running on a system that are required to run a particular task at a certain time. For example, embodiments of the present invention can be used in an alarm clock or game that is dependent on real-life time as an integral part of the game.

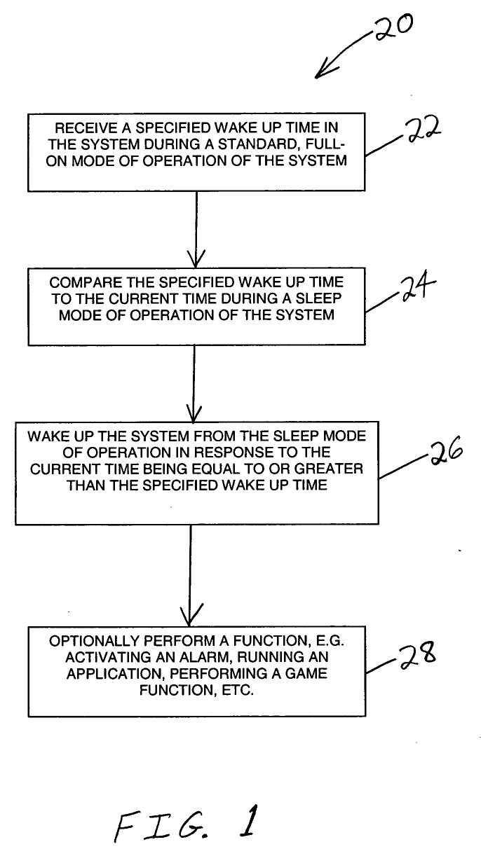

Referring to FIG. 1, there is illustrated a method 20 that operates in accordance with an embodiment of the present invention. The method 20 is useful in systems having a sleep mode of operation. In step 22, the system receives a specified wake up time during its standard, full-on mode of operation. The specified wake up time is the time, which may include the date as well, when the system is to automatically wake up. The specified wake up time may be entered into the system by a user, or received from an application running in the system itself, which will be discussed below.

The specified wake up time is preferably stored in a memory in the system that is persistent when the system is in the sleep mode of operation. For example, the specified wake up time may be saved into either non-volatile memory (memory that is persistent when a device is in sleep mode or powered down) or a spot in memory that is always powered when in sleep mode.

After the specified wake up time is received by the system and the system remains idle for a certain period of time, the system enters the sleep mode of operation as usual. In step 24 the specified wake up time is compared to the current time during the sleep mode. If the current time is equal to or greater than the specified wake up time, then the system wakes up from the sleep mode of operation, which is indicated by step 26. That is, the system wakes up when the current time becomes equal to or surpasses, i.e. becomes greater than, the specified wake up time. The system then returns to its standard mode of operation.

The method 20 allows for new capabilities in portable computing and gaming never seen before. Namely, once the system wakes up from sleep mode and returns to its standard mode of operation, the system can perform a useful or entertaining function as an optional step, which is indicated by step 28. That is, the system could start or continue running an application to execute a function that is to be performed at the time when the system wakes up.

For example, the system could activate an alarm as part of implementing an alarm clock function. Namely, such an alarm clock function would not require the system to be fully powered on for the entire duration until the alarm time. The system could be in a sleep mode or pseudo-sleep mode before it sounds an alarm, drastically saving battery life. The alarm is activated in step 28 after the system wakes up. The alarm that is activated may be, for example, an audible sound, a vibration of the device that the system is embodied in, a visual light, etc. This function could be used to turn a portable gaming device into a viable alarm clock that could be leveraged into making the gaming device more like a personal digital assistant (PDA).

Another example of an application that could make use of the method 20 is a notification application that automatically turns on in step 28 to check something. For example, such notification application could turn on in step 28 and automatically check to see if any of the user's friends or buddies are online, such as after they get off work or school. The application would then notify the user.

And yet another example of an application that could make use of the method 20 is a game application. An example of such a game is a virtual pet game that requires the user to feed and play with a virtual pet at certain times of the day. Namely, after the system wakes up in step 26 the game application could remind the user in step 28 to provide some sort of attention to the virtual pet, like feeding it or taking it for a walk, just like a real pet. Such a game is not possible in conventional battery powered portable devices because having a game fully running twenty-four hours a day seven days a week would drain battery life too quickly.

Furthermore, in one embodiment, the virtual pet game application itself may generate the specified wake up time for the system and not inform the user when the wake up time will be. In such an embodiment the specified wake up time is received from the application running in the system rather than being entered by the user. This can make the game more realistic because the virtual pet will demand attention from the user at random times unknown to the user.

It should be well understood that the example applications and games provided herein are merely a few examples and that numerous other applications and games can make use of the method 20, all in accordance with embodiments of the present invention.

Step 24 in which the specified wake up time is compared to the current time may be implemented in many different ways. Specifically, when a system is in the sleep mode of operation it typically still operates at a very low level. For example, a personal computer (PC) may continue to operate at or even below the BIOS (basic input/output system) level, and a portable game device may continue to operate at or even below the kernel level. Even at these low levels of operation a counter in the system typically still operates to maintain the time and date.

As such, when a battery powered portable device is either in sleep mode or turned off, its battery typically still powers a counter in the system that ticks internally at a certain frequency to keep the device's current time up to date. That counter that continues to operate during sleep mode may be used for the comparison operation of step 24. Namely, in one embodiment of the present invention an “if” statement may be added at the end of some or every tick(s) of the counter to check to see if the current time is equal to or greater than the specified wake up time.

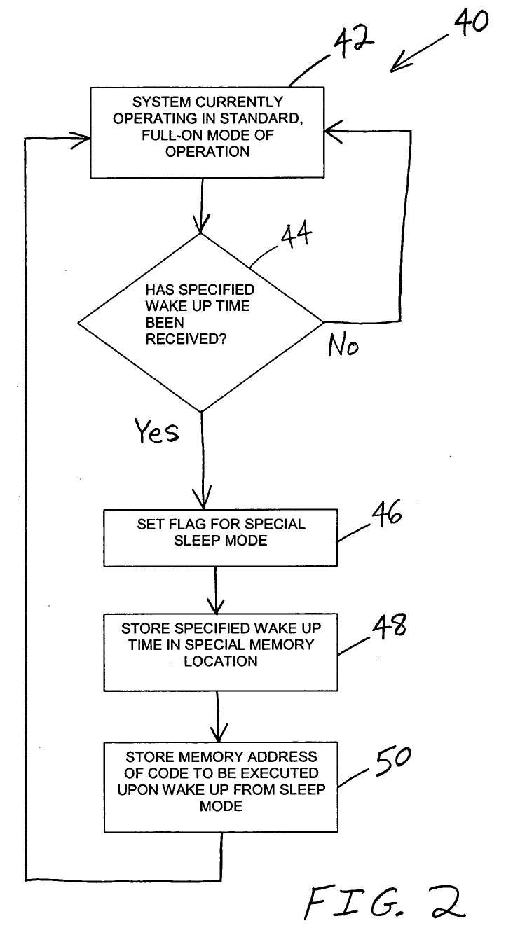

Referring to FIG. 2, there is illustrated a method 40 in accordance with an embodiment of the present invention that may be used for implementing a portion of the method 20 (FIG. 1). Specifically, in step 42 the system is currently operating in the standard, full-on mode of operation. In step 44 the system monitors whether or not it has received a specified wake up time, such as might be entered by a user or generated by an application or game program in the system. If not, the system continues to operate in the standard mode of operation in step 42.

If a specified wake up time (which may include a date as well) has been received, the system sets a flag in step 46 which indicates that a special or pseudo sleep mode of operation should be used. Furthermore, in step 48 the system stores the specified wake up time in a memory location that remains persistent during sleep mode as described above. And in step 50 the system stores the memory address of the code that is to be executed when the system wakes up from the sleep mode. Such code could be, for example, the code for an application or game program such as the alarm clock function discussed above. Then control returns to step 42 where the system continues to operate in the standard mode of operation. As an optional feature the system could receive additional wake up times in step 44.

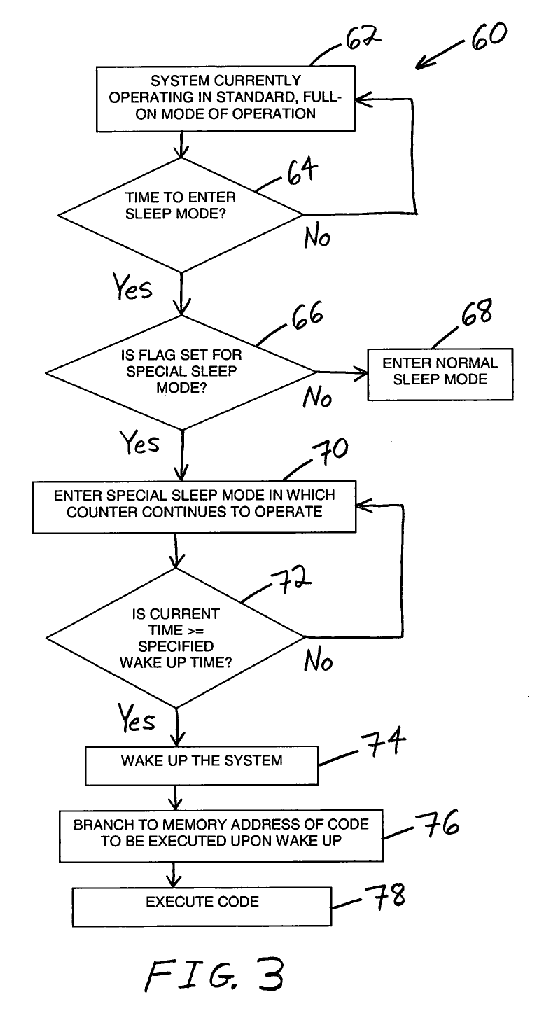

Referring to FIG. 3, there is illustrated a method 60 in accordance with an embodiment of the present invention that may be used for implementing another portion of the method 20 (FIG. 1). Specifically, in step 62 the system is currently operating in the standard, full-on mode of operation. In step 64 the system monitors whether or not it is time to enter the sleep mode of operation, such as by determining whether or not the system has been idle for a certain period of time. If not, the system continues to operate in the standard mode of operation in step 62.

If it is time to enter the sleep mode of operation, then in step 66 the system checks to see if the flag has been set for indicating the special or pseudo sleep mode of operation. If not, the system enters the normal sleep mode of operation in step 68.

If the flag indicating the special or pseudo sleep mode of operation has been set, then the system enters the special sleep mode of operation in step 70. The special sleep mode of operation is a sleep mode in which the system can automatically wake up at a software configurable time as described above. A counter in the system continues to operate in this sleep mode.

In step 72, the system checks to see if the current time is equal to or greater than the specified wake up time at the end of some or every tick(s) of the counter. Additional battery power can be saved by reducing the frequency of these comparisons by allowing more counter ticks between comparisons. If the current time is not yet equal to or greater than the specified wake up time, then the system continues to sleep in step 70.

If the current time is equal to or greater than the specified wake up time, then the system automatically wakes up in step 74 and returns to the standard mode of operation. In step 76 the system branches control to the memory address of the code that is to be executed upon wake up of the system. This code is executed in step 78.

It is noted the comparison step 72 compares whether the current time “is equal to or greater than” the specified wake up time. One reason for the “or greater than” language is because the specified wake up time could be specified in MM/DD/YY Hour:Min:Sec format, which might result in a decimal or float format number. If each clock tick is expressed as an integer (not a decimal or float format number), then the current time in integer format may not ever be exactly equal to the specified wake up time expressed as a decimal number. Therefore, the “or greater than” language is used as a precaution for such issues to make sure the system triggers as soon as the current time surpasses or exceeds the specified wake up time. It should be well understood, however, that there are many different ways the comparison step 72 can be implemented and that it is not limited to the use of the “is equal to or greater than” function. For example, some systems might convert the specified wake up time into an integer number, which means it could end up being exactly equal to the indicated current time, in which case the “or greater than” language might not be needed.

Thus, the method 20 (FIG. 1) provides for a configurable interrupt through software to wake up a system from the sleep mode of operation. This helps to save battery life because the sleep mode can be entered while games and applications are running due to the ability provided by the method 20 to automatically wake up from sleep mode. Such games and applications can allow a user to configure when to run a particular task at a certain time while using minimal battery power. Or, as mentioned above, the games and applications themselves can generate the specified wake up time(s).

The method 20 may be used in many different types of systems. For example, the method 20 may be used in systems that are embodied in battery powered portable devices, such as for example portable computers, notebook computers, PDAs, portable game devices, etc. An example of a portable game device in which the method 20 may be used is the Sony PlayStation Portable PSP™.

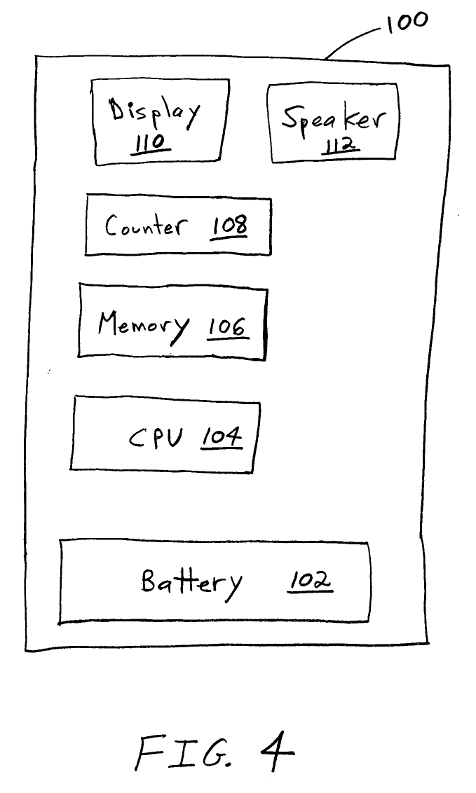

Referring to FIG. 4, there is illustrated a battery powered portable device 100 having a system in which the method 20 may be used in accordance with an embodiment of the present invention. The device 100 may comprise a game device. Specifically, the device 100 may include a battery 102, a central processing unit (CPU) 104, a memory 106, a counter 108, a display 110 and a speaker 112.

The memory 106 is preferably of the type that is persistent when the device 100 is in the sleep mode of operation and can be used for storing the specified wake up time. The counter 108 is preferably configured to continue to operate during the sleep mode of operation or a special sleep mode of operation. The display 110 and/or speaker 112 may be used as alarm indicators to implement the optional alarm function described above.

In order to implement the method 20 (FIG. 1), one or more components of the system, such as the CPU 104, are configured to compare the specified wake up time to the current time at an end of a tick of the counter 108 during the sleep mode of operation. Furthermore, one or more components are configured to wake up the system from the sleep mode of operation in response to the current time being equal to or greater than the specified wake up time. All such configuring may be done through software and/or hardware.

While the invention herein disclosed has been described by means of specific embodiments and applications thereof, numerous modifications and variations could be made thereto by those skilled in the art without departing from the scope of the invention set forth in the claims.

What is claimed is:

1. A method for use in a system having a sleep mode of operation, the method comprising the steps of:
receiving a specified wake up time in the system during a standard mode of operation of the system;
comparing the specified wake up time to a current time during the sleep mode of operation of the system; and
waking up the system from the sleep mode of operation in response to the current time being equal to or greater than the specified wake up time.

2. A method in accordance with claim 1, wherein the step of comparing the specified wake up time to a current time comprises the step of:
using a counter in the system that continues to operate during the sleep mode of operation of the system.

3. A method in accordance with claim 2, wherein the step of comparing the specified wake up time to a current time further comprises the step of:
checking to see if the current time is equal to or greater than the specified wake up time at an end of a tick of the counter.

4. A method in accordance with claim 1, wherein the specified wake up time is stored in a memory in the system that is persistent when the system is in the sleep mode of operation.

5. A method in accordance with claim 1, wherein the step of receiving a specified wake up time in the system comprises the step of:
receiving the specified wake up time from an application running in the system.

6. A method in accordance with claim 1, further comprising the step of:
executing a function that is to be performed at a time when the system wakes up in response to the system waking up.

7. A method in accordance with claim 1, further comprising the step of:
activating an alarm in response to the step of waking up the system.

8. A method in accordance with claim 1, wherein the system comprises a portable device.

9. A method in accordance with claim 1, wherein the system comprises a battery powered game device.

10. A method in accordance with claim 1, wherein the method is used in a virtual pet game.

11. A system having a sleep mode of operation, comprising:
means for receiving a specified wake up time in the system during a standard mode of operation of the system;
means for comparing the specified wake up time to a current time during the sleep mode of operation of the system; and
means for waking up the system from the sleep mode of operation in response to the current time being equal to or greater than the specified wake up time.

12. A system in accordance with claim 11, wherein the means for comparing the specified wake up time to a current time during the sleep mode of operation of the system comprises:
means for checking to see if a current time is equal to or greater than the specified wake up time at an end of a tick of a counter in the system that continues to operate during the sleep mode of operation of the system.

13. A system in accordance with claim 11, wherein the specified wake up time is stored in a memory in the system that is persistent when the system is in the sleep mode of operation.

14. A system in accordance with claim 11, wherein the means for receiving a specified wake up time in the system comprises:
means for receiving the specified wake up time from an application running in the system.

15. A system in accordance with claim 11, further comprising:
means for activating an alarm in response to the waking up of the system.

16. A system in accordance with claim 11, wherein the system comprises a battery powered portable device.

17. A system having a sleep mode of operation, comprising:
a memory that is persistent when the system is in the sleep mode of operation and in which a specified wake up time may be stored;
a counter that continues to operate during the sleep mode of operation of the system;
one or more components configured to compare the specified wake up time to a current time at an end of a tick of the counter during the sleep mode of operation of the system; and
one or more components configured to wake up the system from the sleep mode of operation in response to the current time being equal to or greater than the specified wake up time.

18. A system in accordance with claim 17, wherein the specified wake up time is received from an application running in the system.

19. A system in accordance with claim 17, further comprising:
means for activating an alarm in response to the waking up of the system.

20. A system in accordance with claim 17, wherein the system comprises a battery powered portable device.
